(19) United States
(12) Patent Application Publication
(10) Pub. No.: US 2018/0156450 A1
(43) Pub. Date: Jun. 7, 2018

(54) FUEL NOZZLE OF A GAS TURBINE WITH A SWIRL GENERATOR

(71) Applicant: Rolls-Royce Deutschland Ltd & Co KG, Blankenfelde-Mahlow (DE)

(72) Inventors: Thomas DOERR, Berlin (DE); Carsten CLEMEN, Mittenwalde (DE)

(21) Appl. No.: 15/808,196

(22) Filed: Nov. 9, 2017

(30) Foreign Application Priority Data
Nov. 10, 2016 (DE) 10 2016 222 097.7

(51) Int. Cl. F23D 11/10; F23R 3/14; B05B 1/34; F23C 7/00; F02C 7/22

(52) U.S. Cl. CPC F23D 11/107; F23R 3/14; F05D 2220/32; F23C 7/004; F02C 7/222; B05B 1/3421

(57) ABSTRACT

The invention relates to a swirl generator of a fuel nozzle 6 of a gas turbine, with an inner 22 and an outer 21 ring element, wherein the ring elements 21, 22 are arranged so as to be concentric with respect to each other, and an outer annular channel 18a is formed between the inner ring element 22 and the outer ring element 21, having a radial height of h in its axially central area, characterized in that the outer annular channel 18a has a radial height of H at its inflow area 23 and is provided with air guiding elements 11 in the inflow area 23, wherein H>h applies, wherein an inner annular channel (18b) is formed at the radially inner side of the inner ring element (22), with its inflow area (23), which is provided with air guiding elements (11), having a larger radial height than a central area of the inner annular channel (18b), wherein the outer annular channel (18a) has an effective flow surface (A) in the area of the guide elements (11) that is larger than the effective flow surface in the axially central area of the outer annular channels(18a) without any guide elements, and the cross section of the outer annular channel (18a) tapers off from the inflow area (23) towards an outflow area (24).

The invention relates to a swirl generator of a fuel nozzle of a gas turbine as well as to a fuel nozzle that is provided with the swirl generator.

It is known from the state of the art to arrange fuel nozzles in the area of a head plate of a combustion chamber of a gas turbine in order to inject the fuel, for one thing, and, for another, create the possibility of guiding air into the internal space of the combustion chamber. Within the meaning of the invention, the term ‘gas turbine’ includes aircraft gas turbine engines as well as stationary gas turbines. In an annular combustor, multiple fuel nozzles are provided in a manner distributed about the circumference, being respectively surrounded by a swirl generator at their outflow area. The swirl generator is embodied in a ring-like manner and usually has two annular channels through which air is supplied into the combustion space of the combustion chamber. In each annular channel, air guiding elements are provided in a manner distributed about the circumference, which leads to a swirling of the inflowing air. With two annular channels, the twisting occurs at different swirling angles.

The air guiding elements are embodied in a sheet-metal-like manner or as contoured blades, and reduce or limit the respective amount of air that can flow through the annular channel, as a result of the blocking effect caused by their radial expansion across the channel height and their thickness. With a predetermined radial height of the respective annular channel, which is largely determined by the external diameter of the fuel nozzle and/or the internal diameter of the burner seal, the effective flow surface of the annular channel is thus constructionally predetermined. This in turn leads to a limitation of the amount of air that can be supplied to the combustion chamber. To introduce additional air into the combustion chamber, according to the constructions that are already known from the state of the art, the only possibility is to radially enlarge the swirl generator and/or the main body of the fuel nozzle. As a consequence of this, more installation space is required and also the total weight is increased. Thus, the fuel nozzle with its swirl generator cannot be used in a very flexible manner, if for example larger amounts of air have to be introduced into the combustion space for avoiding soot emissions.

With regards to the state of the art, reference is made to U.S. Pat. No. 6,883,332 B2, US 2002/0162335 A1, U.S. Pat. No. 6,547,163 B1 or U.S. Pat. No. 6,560,964 B2.

The invention is based on the objective to cerate a swirl generator of a fuel nozzle and a fuel nozzle that is provided with the swirl generator which facilitate the supply of a larger amount of air into the combustion chamber while at the same time having a simple structure and being easy and cost-effective to manufacture.

According to the invention, the objective is achieved by the combination of features of the independent claims, with the respective subclaims showing further advantageous embodiments of the invention.

As for the swirl generator, it is thus provided according to the invention that it comprises an outer and an inner ring element, wherein the two ring elements are arranged to be concentric with respect to each other. An outer annular channel is formed between the inner ring element and the outer ring element. Accordingly, when the swirl generator is mounted at the fuel nozzle, an inner annular channel is defined between the main body of the fuel nozzle and the inner ring element. According to the invention it is provided that at least one of the annular channels has a radial height at its inflow area that is larger than a radial height of a central area of the annular channel. According to the invention, the air guiding elements are provided in the inflow area with the larger radial height for creating the swirl.

If the respective radial heights of the outer or of the inner annular channel are dimensioned and chosen in a suitable manner, a considerably enlarged flow surface of the annular channel results in the inflow area, so that a considerably larger amount of air can pass despite the air guiding elements that are arranged in the inflow area. At that, it is not necessary according to the invention to alter the fuel nozzle itself. Rather, thanks to the invention an increase in the air volumes can be achieved in an existing fuel nozzle through the design of the swirl generator. Alternatively, it is possible to use a fuel nozzle that has a smaller diameter, with the outer dimensions of the swirl generator remaining the same, so as to guide a larger amount of air into the combustion chamber. In the latter variant, it is possible to considerably reduce the total weight of the fuel nozzles and of the associated swirl generator. In both variants, it is possible to supply the double amount of air or more as compared to the state of the art.

Further, it is provided that the cross section of the outer annular channel tapers off from the inflow area towards the outflow area. Thus, the annular channel is constructed in a nozzle-like manner. The same applies to the inner annular channel that is defined between the main body of the fuel nozzle and the radially inner ring element.

Through the solution according to the invention it is possible to maintain the number of air guiding elements in the annular channels, which lead to a twisting of the inflowing air, to be the same as in the respectively underlying state of the art. Thus, a sufficient twisting of the air can be achieved while the total amount of air is increased.

In order to explain the invention more clearly, it should be pointed out once more that, according to the invention, the effective flow surface in the inflow area of the outer or of the inner annular channel is larger than the effective flow surface in an axially central area of the respective annular channel. It is to be understood that in annular channels which that are embodied so as to taper off along their axial length, as mentioned above, the resulting differences to the effective flow surface in the inflow area to a respective cross-sectional area may vary. Thus, to explain the invention more clearly, an axially central area is referred to. Here, it should be stressed that the terms ‘axial’ and ‘radial’ respectively refer to a central axis of the fuel nozzle or of the main body of the fuel nozzle.

According to the invention, the tapering of the annular channel can occur in a continuous manner. However, also a step-like change in cross section is possible. Further, the walls of the annular channel according to the invention can be formed in a circular-arc-like or elliptical manner with respect to their cross sections, which results in torus-like wall courses of the annular channel, leading to the mentioned tapering of the cross section, and thus to a reduction of the through-flow surface between the inflow area and a central area.

Further, it is possible according to the invention to arrange the inflow areas of the annular channels in the axial direction or to align them at an angle to the axial direction. It is also possible to align the inflow areas and the openings resulting from them in the radial direction.

To fit the swirl generator according to the invention or the fuel nozzle that is equipped with the swirl generator into an existing combustion chamber construction, it can be advantageous to provide the outer ring element with an external diameter upstream of the head plate and/or of the burner seal that is larger than the internal diameter of the burner seal. In this manner, it is possible to insert the swirl generator itself as well as the fuel nozzle that is provided with the swirl generator into the burner seal in the usual manner from the side of the combustion chamber head, and to mount it at the head plate. Thus, no constructional modifications need to be made to the total structure of the combustion chamber to be used. Of course, also the external diameter of the inflow area of the inner ring element forming the inner annular channel can also be enlarged in a corresponding manner upstream of the head plate.

In the following, the invention is described based on exemplary embodiments in connection with the drawing. Herein:

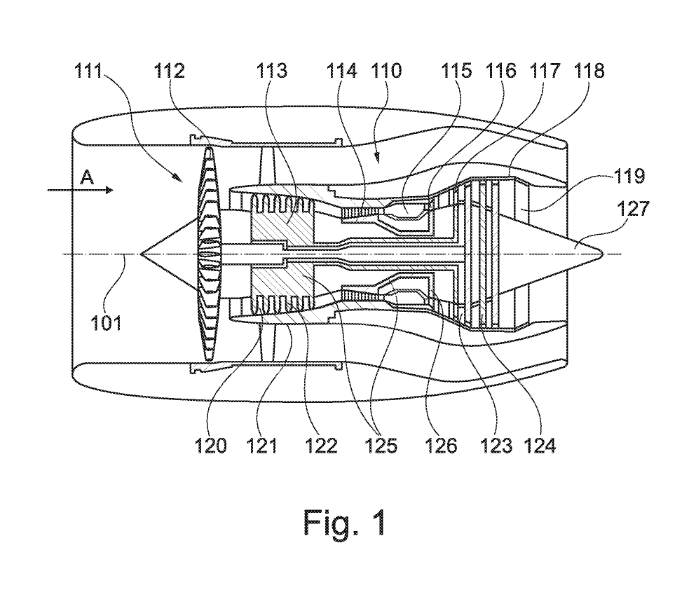

FIG. 1 shows a gas turbine engine for using the invention,

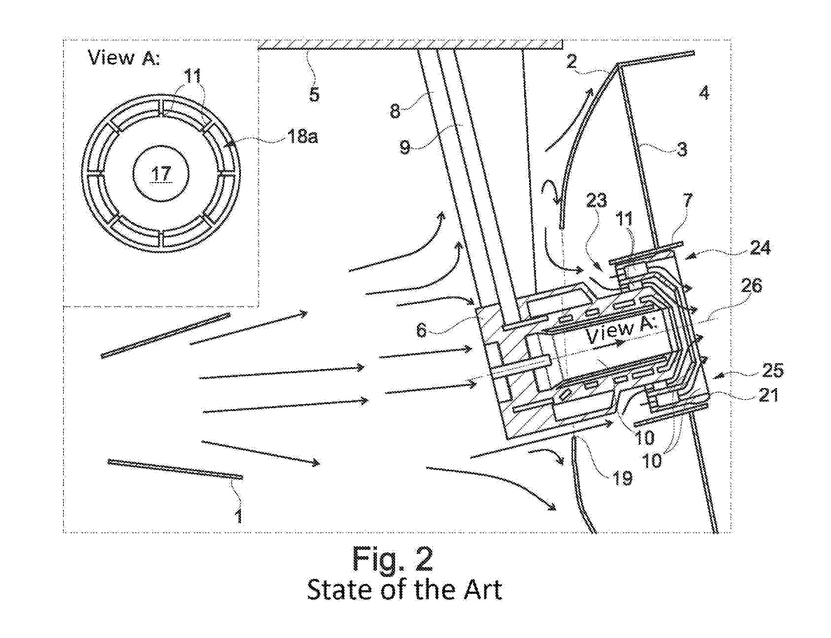

FIG. 2 shows a simplified sectional view of a fuel nozzle with a swirl generator according to the state of the art,

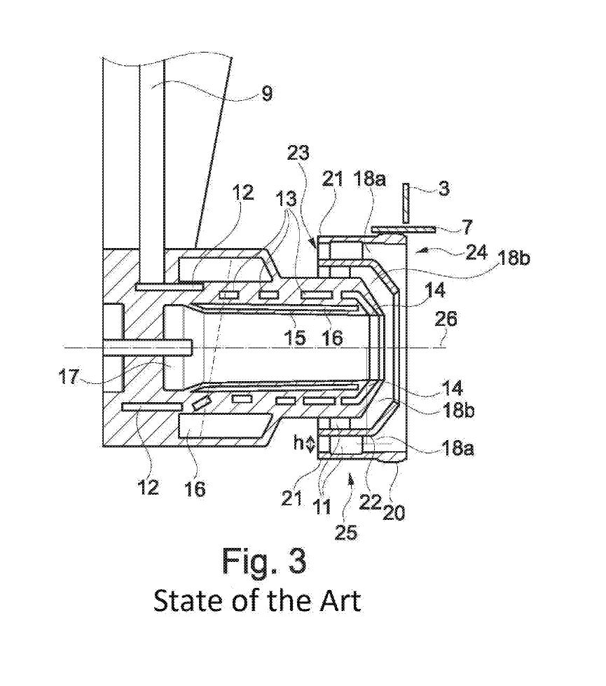

FIG. 3 shows an enlarged rendering of the view of FIG. 2 according to the state of the art,

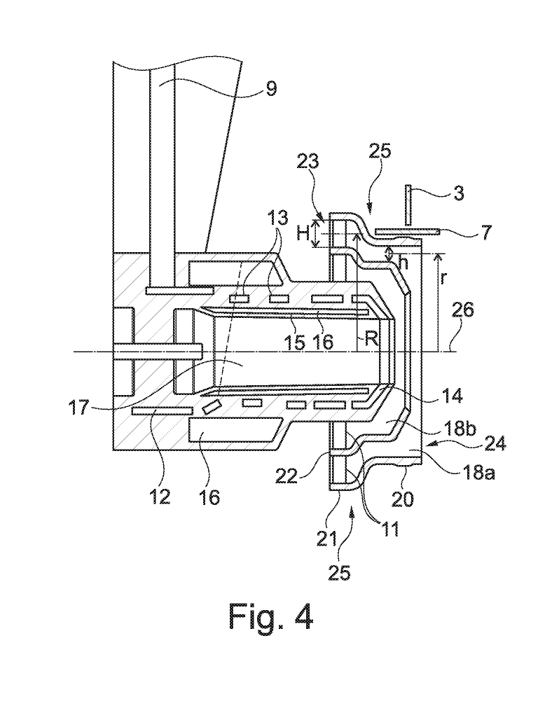

FIG. 4 shows a sectional view of a first exemplary embodiment of the invention, which is analogous to FIG. 3,

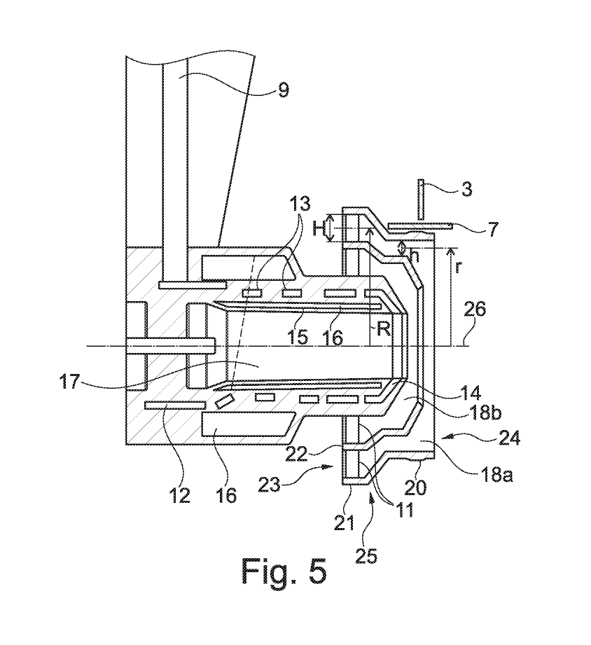

FIG. 5 shows a sectional view of a further exemplary embodiment of the invention, which is analogous to FIG. 4,

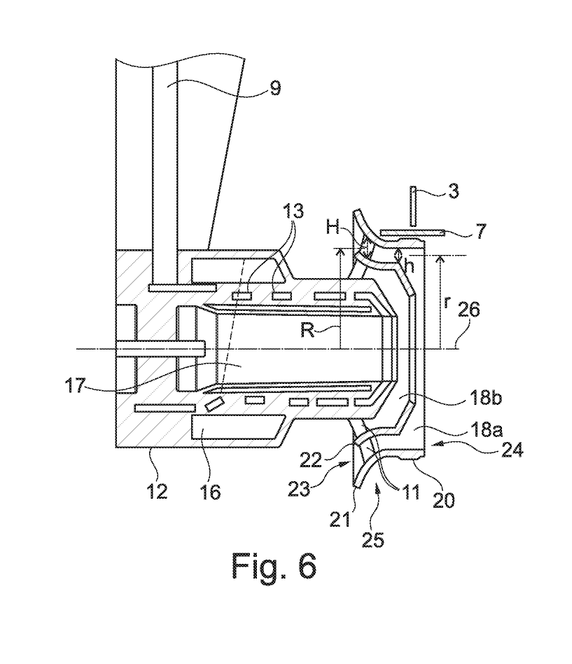

FIG. 6 shows a sectional view of a third exemplary embodiment of the invention, which is analogous to FIGS. 4 and 5, and

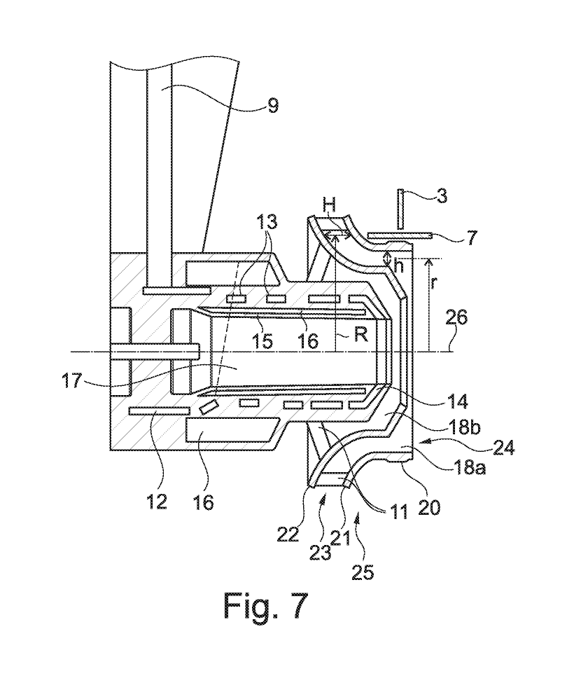

FIG. 7 shows a sectional view of a further exemplary embodiment analogous to the rendering of FIGS. 4 to 6.

The gas turbine engine 110 according to FIG. 1 represents a general example of a turbomachine in which the invention may be used. The engine 110 is configured in a conventional manner and comprises, arranged successively in flow direction, an air inlet 111, a fan 112 that rotates inside a housing, a medium-pressure compressor 113, a high-pressure compressor 114, a combustion chamber 115, a high-pressure turbine 116, a medium-pressure turbine 117, and a low-pressure turbine 118 as well as an exhaust nozzle 119, which are all arranged around a central engine axis 101.

The medium-pressure compressor 113 and the high-pressure compressor 114 respectively comprise multiple stages, of which each has an arrangement of fixedly arranged stationary guide vanes 120 that extends in the circumferential direction, with the stationary guide vanes 120 being generally referred to as stator vanes and projecting radially inward from the core engine shroud 121 through the compressors 113, 114 into a ring-shaped flow channel. Further, the compressors have an arrangement of compressor rotor blades 122 that project radially outward from a rotatable drum or disc 125, and are coupled to hubs 126 of the high-pressure turbine 116 or the medium-pressure turbine 117.

The turbine sections 116, 117, 118 have similar stages, comprising an arrangement of stationary guide vanes 123 projecting radially inward from the housing 121 through the turbines 116, 117, 118 into the ring-shaped flow channel, and a subsequent arrangement of turbine blades/vanes 124 projecting outwards from the rotatable hub 126. During operation, the compressor drum or compressor disc 125 and the blades 122 arranged thereon as well as the turbine rotor hub 126 and the turbine rotor blades/vanes 124 arranged thereon rotate around the engine central axis 101.

FIGS. 2 and 3 show constructions according to the state of the art, illustrating the underlying structure of the fuel nozzle as well as of an associated swirl generator. The renderings are respectively shown in an axial section plane that comprises a central axis 26 of a fuel nozzle 6 or of a main body of the fuel nozzle. In addition, Figure shows a simplified view A according to FIG. 2.

Thus, FIGS. 2 and 3 show a 3-flow fuel nozzle 6 according to the state of the art in the sectional view. This construction follows from the above-mentioned printed documents. Further, FIGS. 2 and 3 illustrate the arrangement of the fuel nozzle 6 in a combustion chamber 115 of the gas turbine. In the usual design, the combustion chamber has a combustion chamber head 2 that is provided with a respective opening through which the fuel nozzle 6 is mounted and which is dimensioned in such a manner that an air flow 19 can pass through the combustion chamber head.

In the schematic rendering of FIG. 2, a combustion space 4 is shown, being delimited by a head plate 3 at the front-face side. A burner seal 7 is formed at the head plate 3.

The supplied air flows from a high-pressure compressor, which is not shown, through a diffusor 1 in the direction of the combustion chamber head 2, and subsequently, as mentioned, as an air flow 19 through a recess of the combustion chamber head into the intermediate area between the combustion chamber head 2 and the head plate 3. The main body of the fuel nozzle 6 is provided with a centric air channel 17 (see FIGS. 4 to 7) through which a portion of the total air volume is guided into the combustion space 4. The fuel nozzle 6 is attached to an outer housing 5 and projects into the combustion space 4 through the burner seal 7. The mentioned burner seal 7 leads to a sealing between the head plate 3 and the swirl generator 25 that surrounds the main body of the fuel nozzle 6.

The fuel nozzle 6 has a shaft 8 through which a fuel supply 9 is realized. The fuel is conducted into a circumferential chamber 12 through the supply line 9, and subsequently flows through fuel channels 13 to the injection nozzle 14. The fuel nozzle has inner heat shields 15 and/or isolation chambers 16 for shielding the fuel from the air. As shown in FIG. 3, the sealing between the swirl generator 25 and the burner seal 7 is realized by means of at least one sealing element 20, which may be embodied in the form of an annular bead.

While in FIG. 2 the three air channels 10 of the 3-flow fuel nozzle are provided with the same reference sings, FIG. 3 illustrates that, in addition to the centric air channel 17, two further annular channels that are concentric to each other are formed through the swirl generator 25, namely an outer annular channel 18a and an inner annular channel 18b. These annular channels 18a and 18b are defined by an outer ring element 21 and an inner ring element 22.

FIG. 3 shows that air guiding elements 11 are respectively arranged inside the inflow area 23 of the annular channels 18a and 18b. They are distributed evenly about the circumference, as can be seen from the view A of FIG. 2. With a view to explaining the invention more clearly, only the outer annular channel 18a with the air guiding elements 11 arranged therein is shown in the schematic rendering of view A of FIG. 2.

With respect to FIG. 3, it follows that a radial height h of the outer annular channel extends substantially across the entire axial length of the outer annular channel 18a, so that the effective through-flow surface is determined as the radial height h minus the cross-sectional surfaces of the air guiding elements 11, as illustrated in the view A of FIG. 2. The air guiding elements 11 respectively have a thickness D and a number N, and extend across the entire height h of the outer annular channel 18a. Thus, the air guiding elements 11 block the free cross section of the outer annular channel 18a and lead to a decreased amount of air being able to pass through the annular channel. This analogously applies to the inner annular channel 18b with the air guiding elements 11 arranged therein, see FIG. 3.

As is further shown in FIG. 3, the air channels 18a and 18b extend in the axial direction, wherein the course of the annular channels is cylindrical. The narrowest cross section of the respective annular channels thus results in the area of the air guiding elements (swirl elements) 11.

To obtain a higher air flow in the constructions that are known from the state of the art, it is necessary to enlarge the effective flow surface through the annular channels 18a, 18b. This may for example be realized by decreasing the thickness of the air guiding elements, by changing the applied swirl of the air guiding elements, or by decreasing the number of air guiding elements. However, such constructional modifications are often not possible or not desirable, and in addition entail further constructional modifications to the combustion chamber itself.

In the constructions that are known from the state of the art, the through-flow surface expands downstream of the air guiding elements 11, as these no longer obstruct the free cross section. In this way, a diffusor effect sets in, slowing down the air flow.

The through-flow surface of the annular channels 18a, 18b through the guide elements can be determined as follows:

height of the annular channel 18a, 18b in the area of the guide elements 11: h

central radius of the respective annular channel:

number of the guide elements: N

maximum thickness of the guide element 11: D

pi π

This results in a flow-passable surface a:

a=2×π×r×h−N×h×D

FIGS. 4 to 7 respectively show exemplary embodiments of the invention, wherein the rendering is respectively analogous to FIG. 3. The same parts are respectively indicated by the same reference signs.

As shown in FIGS. 4 to 7, the narrowest cross section of the outer annular channel 18a or of the inner annular channel 18b is determined by the radial height h of the respective annular channel. To provide a better understanding, FIGS. 4 to 7 respectively refer to the outer annular channel 18a. However, in contrast to the state of the art, according to the invention the air guiding elements 11 are arranged upstream of this narrowest cross section h, and are combined with a larger radial height H of the respective annular channel. At that, the channel height H is chosen as a multiple X of the channel height h in such a manner that the effective flow surface A in the area of the air guiding elements 11 is larger than the through-flow surface which is defined by the channel height h and the central radius r in the area of the channel height h. Thus, the through-flow surface a in the inflow area 23 results from the air guiding elements 11 that are arranged there, from the radius R present there (central radius in the area of the air guiding elements 11), the radial channel height H, and the surface that is blocked by the air guiding elements 11, with the number, the thickness and the height of the air guiding elements 11 being taken into account:

A=2×π×R×H−N×H×D.

Thanks to the solution according to the invention, the annular channels can be dimensioned in such a manner that the result is a significant increase in the amount of air to be passed though, for example by up to 100%.

To realize an inflow area 23 with an enlarged diameter, it is necessary to dimension the two annular channels 18a and 18b in a suitable manner. This is performed by enlarging the external diameter of the swirl generator 25 upstream of the head plate 3 in order to realize the channel height H there. According to the invention, the shape of the outer annular channel 18a and of the inner annular channel 18b is chosen in such a manner that, starting from the channel height H, the respective annular channel tapers off from the trailing edge of the air guiding element 11 to the narrowest channel height h. This is achieved by designing the outer ring element 21 and the inner ring element 22 in a suitable manner.

The exemplary embodiments of FIGS. 4 to 7 differ with respect to the design and the course of the respective annular channels 18a and 18b, or the shape of the ring elements 21 and 22.

What follows from the exemplary embodiment according to FIG. 4 is a design of the inflow area 23 in an axially parallel arrangement, so that both annular channels 18a and 18b with the air guiding elements 11 that are provided therein in the respective inflow area 23 are arranged in the axial direction. A respective outflow area 24 is dimensioned in the usual manner, to adjust the swirled air flow to the air flow through the centric air channel 17 as well as to the fuel jet that is discharged from the injection nozzle 14. This is known from the state of the art and does not need to be described herein in more detail. According to FIG. 4, the transition between the individual cross-sectional areas is realized through a substantially rounded shape. FIG. 5 shows an exemplary embodiment in which respectively linear wall areas of the ring elements 21 and 22—with respect to the sectional view of FIG. 5—are provided, the result being a step-wise reduction of the cross-sectional surface. In the exemplary embodiment of FIG. 6, the inflow area 23 is arranged at an angle to the central axis 26, the walls are provided with a circular-arc-like or elliptical cross-sectional area.

In the exemplary embodiment of FIG. 7, the inflow area 23 of the outer annular channel 18a is positioned in the radial direction.

As follows from a comparison of FIGS. 3 to 7, the axial installation length of the swirl generator 25 or the fuel nozzle 6 according to the invention is the same as in the state of the art, so that no constructional modifications of the combustion chamber, in particular of the combustion chamber head 2, are necessary.

A comparison in particular of FIGS. 4 to 7 with FIG. 3 shows that, according to the invention, the through-flow surface is enlarged in the area of the air guiding elements. To calculate the effective flow surface A, the central radius R at the trailing edge of the guide element 11 is taken into account for the following comparison, as is the radial channel height H at the trailing edge of the guide element, and the maximum thickness D of the guide element. For the sake of the following comparison, the through-flow surface A in the area of the guide elements 11 is respectively multiplied by the CD factor of 0.8:

state of the art: channel height H=2 mm, radius r=13.75 mm, surface A=173 mm²

minus the air guiding elements 11:

for example, 40 air guiding elements with respectively 1 mm thickness

CD=0.8

effective surface a=74 mm²

In contrast, what results with the invention is the following:

channel height H=4 mm, radius R=15 mm, surface=377 mm²

minus the air guiding elements:

for example, 40 air guiding elements with respectively 1 mm thickness

CD=0.8

effective surface A=174 mm²

effective surface a=173 mm²

What follows from this is that, in the chosen example, more than a doubling of the effective flow surface is realized. Thus, the total result according to the invention is an increased effective surface of both outer annular channels 18a and 18b. In this manner, the possibility of either passing through a larger amount of air with the same external diameter of the fuel nozzle 6 to thus create a positive impact on emissions, or of realizing the same surface with a smaller diameter of the fuel nozzle 6 to reduce the total weight of the fuel nozzle is created.

### PARTS LIST

1 diffusor

2 combustion chamber head

3 head plate

4 combustion space

5 outer housing

6 fuel nozzle/main body

7 burner seal

8 shaft

9 fuel supply

10 air channel

11 air guiding element

12 circumferential chamber

13 fuel channel

14 injection nozzle

15 heat shield

16 isolation chamber

17 centric air channel

18a outer annular channel

18b inner annular channel

19 air flow

20 sealing element

21 outer ring element

22 inner ring element

23 inflow area

24 outflow area

25 swirl generator

26 central axis

101 engine central axis

110 gas turbine engine/core engine

111 air intake

112 fan

113 medium-pressure compressor (compactor)

114 high-pressure compressor

115 combustion chamber

116 high-pressure turbine

117 medium-pressure turbine

118 low-pressure turbine

119 exhaust nozzle

120 guide vanes

121 core engine housing

122 compressor rotor blades

123 guide vanes

124 turbine vanes/blades

125 compressor drum or compressor disc

126 turbine rotor hub

127 outlet cone

1. A swirl generator of a fuel nozzle of a gas turbine, with an inner and an outer ring element, wherein the ring elements are arranged so as to be concentric with respect to each other, and an outer annular channel is formed between the inner ring element and the outer ring element, having a radial height of h in its axially central area, wherein the outer annular channel has a radial height of H at its inflow area and is provided with air guiding elements in the inflow area, wherein H>h applies, wherein an inner annular channel is formed at the radially inner side of the inner ring element, with the inflow area of the inner annular channel, which is provided with air guiding elements, having a larger radial height than a central area of the inner annular channel, wherein the outer annular channel has an effective flow surface in the area of the guide elements that is larger than the effective flow surface in the axially central area of the outer annular channel without any guide elements, and the cross section of the outer annular channel tapers off from the inflow area towards an outflow area.

2. A fuel nozzle of a gas turbine, with a tube-like main body that is provided with fuel channels and is arranged at its outflow area in a swirl generator, wherein the swirl generator is arranged in a burner seal that is arranged at a head plate, characterized in that wherein the swirl generator is formed according to claim 1.

3. The fuel nozzle according to claim 2, wherein the outer ring element has a larger external diameter upstream of the head plate and/or the burner seal than the internal diameter of the burner seal.

4. The fuel nozzle according to claim 2, wherein an inner annular channel is formed between the main body and the inner ring element, having a radial height of H in its inflow area, wherein H>h applies, with h being the radial height of an axially central area of the inner annular channel.

5. The fuel nozzle according to claim 2, wherein the annular channels taper off from the inflow area towards the outflow area.

6. The fuel nozzle according to claim 5, wherein the tapering off is realized in a continuous or stepped manner, or with a circular-arc-like or elliptical curvature.

7. The fuel nozzle according to claim 2, wherein the inflow areas are arranged in the axial direction at an angle to the axial direction, or in the radial direction.
